(19) United States
(12) Patent Application Publication
(10) Pub. No.: US 2023/0252345 A1
(43) Pub. Date: Aug. 10, 2023

(54) GENERATING NEGATIVE SAMPLES FOR SEQUENTIAL RECOMMENDATION

(71) Applicant: salesforce.com, inc., San Francisco, CA (US)

(72) Inventors: Yongjun Chen, Palo Alto, CA (US); Jia LI, Mountain View, CA (US); Nitish Shirish Keskar, San Francisco, CA (US); Caiming Xiong, Menlo Park, CA (US)

(21) Appl. No.: 17/827,334

(22) Filed: May 27, 2022

Related U.S. Application Data
(60) Provisional application No. 63/307,582, filed on Feb. 7, 2022.

(51) Int. Cl. G06N 20/00

(52) U.S. Cl. CPC G06N 20/00

(57) ABSTRACT

Embodiments described herein provide methods and systems for training a sequential recommendation model. A system receives a plurality of user behavior sequences, and encodes those sequences into a plurality of user interest representations. The system predicts a next item using a sequential recommendation model, producing a probability distribution over a set of items. The next interacted item in a sequence is selected as a positive sample, and a negative sample is selected based on the generated probability distribution. The positive and negative samples are used to compute a contrastive loss and update the sequential recommendation model.

### CROSS REFERENCES

The present disclosure is a nonprovisional of and claims priority under 35 U.S.C. 119 to U.S. provisional application No. 63/307,582, filed on Feb. 7, 2022, which is hereby expressly incorporated by reference herein in its entirety.

### TECHNICAL FIELD

The embodiments relate generally to sequential recommendation models, and more specifically to systems and methods for negative interest sampling and prediction in sequential recommendation models.

### BACKGROUND

Sequential Recommendation (SR) models are trained to generate a sequence of recommendations to a user by predicting a user's preferences based on user behaviors. In the real world, a user's interests and dislikes (negative interests) change over time. For example, a user may start to like an item she disliked in the past. However, a trained SR model may not accurately predict a user's preferences due to changes in negative interests. Some SR models may treat items that are randomly sampled from a user's non-interacted item set as negative interests. Such assumptions can be uninformative, resulting in inaccurate learned user preferences towards items, particularly when the user's disliked items can change over time. Therefore, there is a need to provide high quality negative samples that truthfully reflect user's dislikes over such items for training SR models.

### BRIEF DESCRIPTION OF THE DRAWINGS

FIG. 1 illustrates an exemplary user historical behavior sequence according to some embodiments.

FIG. 2 illustrates an exemplary sequential recommendation model according to some embodiments.

FIG. 3 illustrates an exemplary next negative item sampler according to some embodiments.

FIG. 4 illustrates a simplified diagram of a computing device that generates negative items according to some embodiments.

FIG. 5 provides an example logic flow diagram illustrating an example algorithm for training a sequential recommendation model, according to some embodiments.

FIG. 6 provides an example logic flow diagram illustrating an example algorithm for sampling negative items, according to some embodiments.

FIGS. 7-11 provide example tables illustrating performance of different models according to some embodiments.

In the figures, elements having the same designations have the same or similar functions.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

Sequential Recommendation (SR) is utilized to predict the next item a user is interested in based on past behaviors (e.g., shopping, clicking, etc.). To achieve such predictions, a model may train a neural network based on user's preferences towards a target set of items (for example, all or a subset of items available in an online store) at each time step. In the real world, a user's interests and dislikes (negative interests) change over time. As a result, effective models should be able to leverage a user's current interests and model parameters to provide the user's truly disliked and informative information.

One method of training a sequential recommendation model is through contrastive learning. For example, a positive training pair of prior items and a positive sample that corresponds to the next item, and a negative training pair of prior items and a negative sample that does not correspond to the next item may be both input to the encoder, and the contrastive loss pulls the positive samples closer while pushing negative samples away in the feature space. In some training methods, the positive sample is chosen from the ground truth of the actual next item selected in a user sequence. In some training methods, the negative sample is chosen randomly from the set of items. However, selecting an item completely at random has low value in training the model. In view of this, there is a need for improved training methods for sequential recommendation models, including the selection of negative samples.

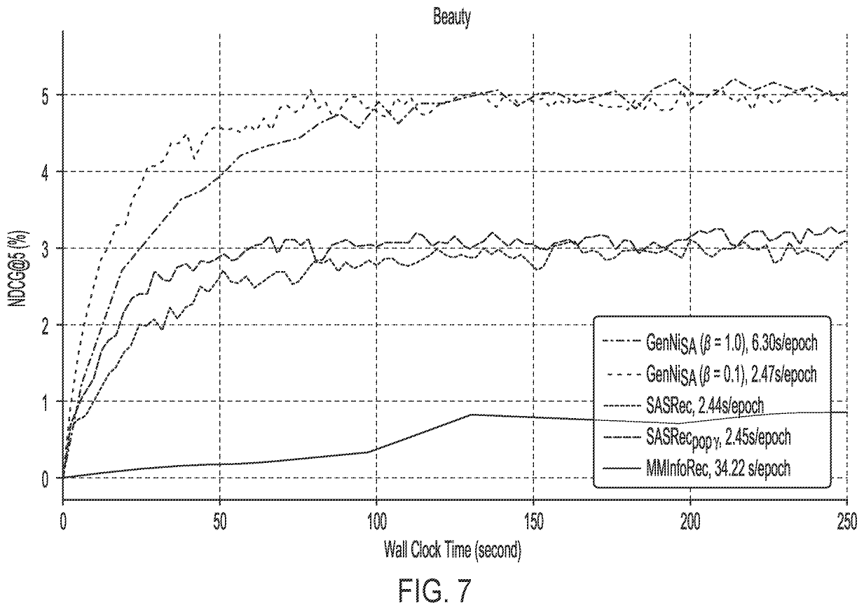

In view of need of providing high quality negative samples, embodiments described herein provide a model of Generating Negative items (GenNi) for SR. At a high level, at each time step during the training stage, a negative item is sampled based on the current next item prediction of the model using updated model parameters as of the time step, produced by finding the similarity between the current SR model learned user interests and the item embeddings. GenNi adaptively generates negative samples without training additional generative modules beyond the SR model itself. Without the need for a separate model for selecting negative samples, computation cost, memory, power, etc. may be reduced compared to other methods, while improving the rate of training and/or the accuracy of the model. GenNi is scalable to large-scaled recommendation tasks. For example, GenNi may take accelerate training by sparsely sampling the items when generating negative samples. The sampling may remain sparse during training, or may decrease as the model is fine-tuned. Human efforts of tuning the hyperparameters in GenNi can be alleviated through a self-adjusted curriculum learning strategy. As shown in FIGS. 7-11, SR models trained using GenNi achieve superior performance compared with other existing SR models.

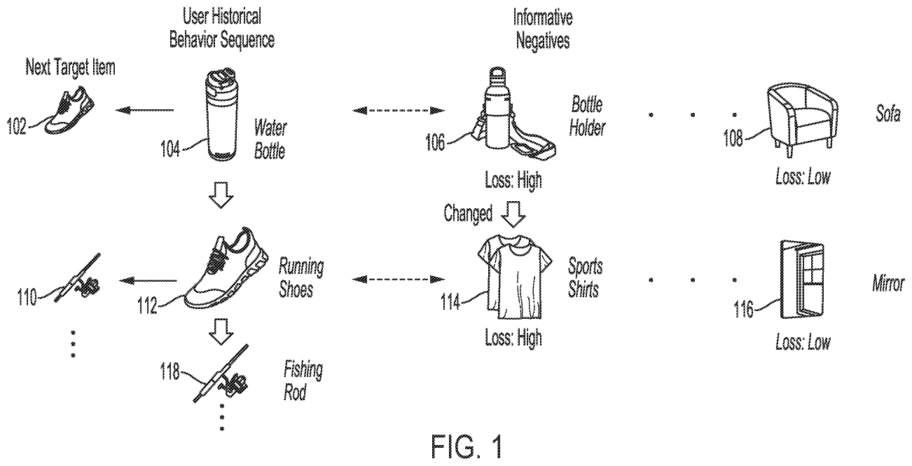

FIG. 1 illustrates an exemplary user historical behavior sequence according to some embodiments. A user historical behavior sequence, generated by observing user behavior, contains items 104, 112, and 118, which in this example are respectively a water bottle, running shoes, and a fishing rod. The user historical behavior sequence may continue beyond the fishing rod with other items not shown. A sequential recommendation (SR) model may be used to predict the next item in the sequence. In order to train the SR model, a contrastive learning paradigm may be used, which at each step uses a positive and a negative sample to compute a contrastive loss. To implement the contrastive learning, at each step, a positive and negative sample may be determined. The positive sample may be the next item in the actual user historical behavior sequence from training data. Here, the next target item 102 after water bottle 104 is the running shoes. The next target item 110 after the running shoes 112 is the fishing rod 118.

For the negative sample, different methods of selecting the item may be used. In some methods, the negative sample is chosen at random with a uniform probability distribution across all available items. In general, a randomly selected item, however, is not informative to the model, and will produce a low contrastive loss. For example, an informative negative sample after water bottle 104 would be bottle holder 106 which may produce a high contrastive loss. Randomly selected item sofa 108 would produce a low loss, and not be very informative to the model. Likewise, sports shirts 114 are an informative negative sample after running shoes 112, compared to uninformative mirror 116. Therefore, by selecting “informative” negative samples that carry learned knowledge from the prior user behavior sequence, training performance of the SR model may be enhanced. The Generating Negative items (GenNi) approach selects informative negative samples without training an additional generative model but by basing the selection of negative samples on the SR model's current next item prediction to select the more likely rather than random items. For example, the current predicted next item that is not the actual next item (positive sample) in the user historical behavior sequence can be used as a negative sample.

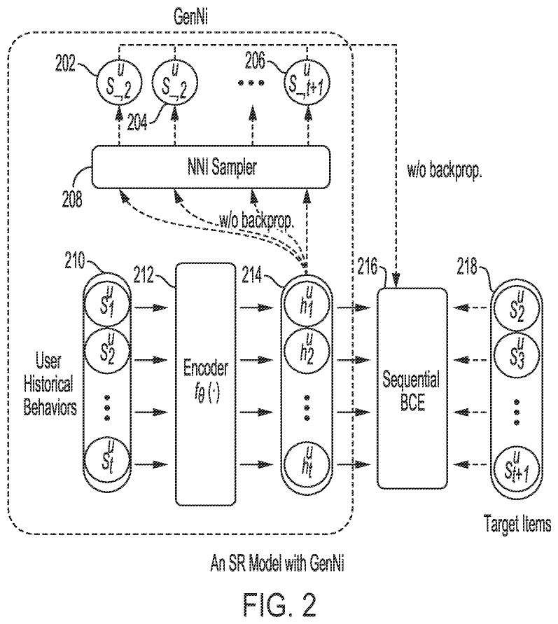

FIG. 2 illustrates an exemplary sequential recommendation model being trained by contrastive learning using positive samples and negative samples described in FIG. 1, according to some embodiments. FIG. 2 shows an input data of user historical behaviors 210. In a recommender system, the set of users and items are denoted as U and V respectively. Each user u∈U is associated with a sequence of interacted items sorted in chronological order, such as user historical behaviors 210 represented as Su=[s₁^{u}, . . . , sₜ^{u}, . . . , s_{|S}_{^{u}}_{|}^{u}] where |S^{u}| is the number of interacted items and sₜ^{u} is the item u interacted with at step t. S^{u} is the embedded representation of S^{u}, where sₜ^{u} is the d-dimensional embedding of item sit′. In practice, sequences are truncated with maximum length T. If the sequence length is larger than T, the most recent T actions are considered. If the sequence length is smaller than T, “padding” items will be added to the left until the length is T. For each user u at time step t, the goal of SR is to predict the item that the user u would be interested in at step t+1 among the item set V, given her past behavior sequence S_{1:t}^{u}.

To train an SR model, a learning procedure fits the sequential data following the maximum likelihood estimation principle. Specifically, for each user u at position step t in a mini-batch B, an encoder 212 (represented by parametric function ƒθ) encodes an input of user historical sequence 210. Encoder 212 is trained to maximize the probability of the target item, computed as:

$$arg max θ {\sum }_{( u , t ) ∈ B} {P}_{θ} ( {s}_{t + 1}^{u} \vert {h}_{t}^{u} ) \\ where \\ {P}_{θ} ( {s}_{t + 1}^{u} \vert {h}_{t}^{u} ) = \frac{exp ( {h}_{t}^{u} \cdot {s}_{t + 1}^{u} )}{{Z}_{θ} ( {h}_{t}^{u} )}$$

Where hₜ^{u}=ƒ_{θ}(S_{1:t}^{u}) is the encoded user's interest representation at time t, Z_{θ}(hₜ^{u}=∈_{v∈V}hₜ^{u}·v is the partition function that normalizes the score into a probability distribution, and exp(hₜ^{u}·sₜ₊₁^{u}) is a similarity score of a user's preference toward the target item. Computing this probability as well as its derivatives may be infeasible since the Z_{θ}(⋅) term requires summing over all items in V, which is generally of large-scale in sequential recommendation. The encoder 212 may thereby be trained to generate the encoded user interest representations 214.

Encoder 212 may also encode the user historical behaviors 210 using noise contrastive estimation (NCE) as described in Gutmann et al., Noise-Contrastive Estimation of Unnormalized Statistical Models, with Applications to Natural Image Statistics, Journal of machine learning research 13, 2, 2012. NCE is based on the reduction of density estimation to probabilistic binary classification. It provides a stable and efficient way to avoid computing Zθ(⋅) while estimating the original goal. The basic idea is to train a binary classifier to discriminate between samples from the positive data distribution and samples from a “noise” (negative sampling) distribution. Specifically, given the encoded user interest hₜ^{u} of user interest representations 214, the next item sₜ₊₁^{u} is viewed as its positive item and the sampled k negative items from a pre-defined distribution function Q(⋅) (e.g., a uniform distribution over all other items in V). The SR model's encoder 212 may be trained with the following loss function, which may be implemented by sequential binary cross entropy (BCE) 216:

$$L = {\sum }_{( u , t ) ∈ B} {L}_{t}^{u} \\ and \\ {L}_{t}^{u} = - log ( P ( D = 1 \vert {h}_{t}^{u} , {s}_{t + 1}^{u} ) ) - k {𝔼}_{neg \sim Q} log ( P ( D = 0 \vert {h}_{t}^{u} , {s}_{- , t + 1}^{u} ) )$$

Where P(D=1|hₜ^{u},sₜ₊₁^{u})=π(hₜ^{u}·sₜ₊₁^{u}), σ is a sigmoid function, and s_{-,t+1}^{u} is the sampled negative item at t+1. This loss decreases when hₜ^{u}·sₜ₊₁^{u} increases and hₜ^{u}·s_{-,t+1}^{u} decreases. In other words, optimizing this loss function is equivalent to pulling the sequence embedding hₜ^{u} closer to the positive item sₜ₊₁^{u} whilst pushing away from sampled negative items, thus being contrastive. To effectively train a SR model via NCE, one may increase the negative sampling rate k or improve the quality of the negative sampling distribution Q(⋅).

As illustrated, a SR model with GenNi includes as inputs user historical behaviors 210. User historical behaviors 210 are encoded by encoder 212 to produce user interest representations 214. Next negative item (NNI) sampler 208 selects negative samples (e.g., negative samples 202, 204, and 206) based on the user interest representation 214. A contrastive loss is computed, for example by sequential binary cross entropy (BCE) 216 (or more generally by a contrastive loss module). Positive samples 218 are based on next items from user historical behaviors 210. Negative samples are those produced by NNI sampler 208. The loss produced by BCE 216 may be used to update the parameters of the encoder 212.

Specifically, at each time step t, a user historical behavior sequence 210 is encoded by encoder 212: hₜ^{u}=ƒ_{θ}(S_{1:t}^{u}). Then the model leverages the current sequential dynamic hₜ^{u} and the model's current state (parameterized by θ) to generate next informative negative item. The sampling function Q(⋅) which may be performed by NNI sampler 208 is defined as follows:

$$Q ( {s}_{i} \vert {h}_{t}^{u} , {\hat{θ}}_{l} ) = {( \frac{exp ( {s}_{i , {\hat{θ}}_{l}} \cdot {h}_{t , {\hat{θ}}_{l}}^{u} )}{{\sum }_{{s}_{i} ∈ V} exp ( {s}_{i , {\hat{θ}}_{l}} \cdot {h}_{t , {\hat{θ}}_{l}}^{u} )} )}^{α} , {s}_{i} \neq {s}_{t + 1}^{u}$$

Where \hat{θ}ₗ is the estimated model parameters at lth learning iteration and a controls the difficulty of the sampler. When α=0, the sampler follows a uniform distribution. The larger α, the more informative item is more likely to be sampled, as it exaggerates the probability distribution. The Q(⋅) function is both dynamic to the changes of user's interests over each time step t and also adaptive to the model's learning state over each training iteration 1. The next negative item (NNI) sampler 208 may be a decoder which implements the Q(⋅) function. This may be considered a form of self-adversarial training as the model itself is producing the negative samples. In some embodiments, the sampler 208 samples a plurality of negative samples per one next item prediction at one training time step. In other embodiments, only one negative sample is sampled per one next item prediction at one training time step.

The summation over all the items in the denominator of the Q(⋅) function may be undesired when there are a large number of items, or when it is otherwise desired to train more rapidly or with fewer compute resources. A sampling strategy may be used to accelerate the sampling procedure. Specifically, at a certain time step, a negative item may be sampled using a pre-selection and a post-selection. At pre-selection, a small subset of candidate items is pre-selected from V. Candidate items may be uniformly selected according to a ratio defined by parameter β. Pre-selected items may be denoted by V′⊂V. At post-selection, the next negative item sampler 208 may be used to further narrow down the nominated items V′ and serve to the user:

$$Q ( {s}_{i} \vert {h}_{t}^{u} ) = {( \frac{exp ( {s}_{i} \cdot {h}_{t}^{u} )}{{\sum }_{{s}_{i} ∈ {V}^{′}} exp ( {s}_{i} \cdot {h}_{t}^{u} )} )}^{α} , {s}_{i} \neq {s}_{t + 1}^{u}$$

With the acceleration, the computation time of negative item generation reduces from the original O(|V|0 to O(β·V), where β ranges from 0 to 1. When β≈0, sampling becomes uniform (and post-selection is not needed). When β=1, pre-selection is no longer needed, which becomes the same as Q(sᵢ|hₜ^{u},\hat{θ}ₗ) controls the trade-off between effectiveness and efficiency. There are two main strategies for setting β. First, a fixed value may be selected for β. This approach has the benefit of simplicity, and may save the most computation cost. However, over the course of training, the number of informative items becomes less and less as most of the items are already considered as negatives by the SR model. Having a small β value can potentially filter out all the informative items in later training stage, so the model will stop learning. In some embodiments, can be small without a large performance drop. As second approach is gradually increasing as training proceeds. For example, based on equation:

β=min(0.001·10^{E}^{ᵢ}^{/m},1.0)

Where Eᵢ denotes the i^{th} training epoch and m controls how fast increases. Items sampled from a uniform distribution can be informative in initial stages because the SR model hasn't started to learn. Most of them may become uninformative as the training continues. By gradually increasing informative items can always be sampled while reducing computation cost compared with the full version (fixed β=1.0)

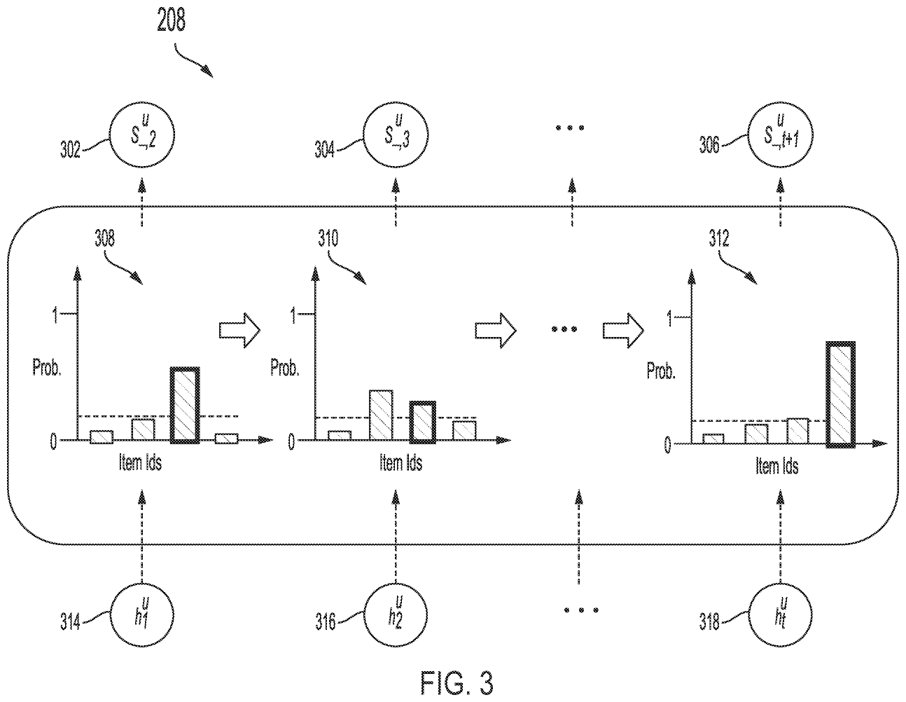

FIG. 3 illustrates an exemplary next negative item (NNI) sampler 208 configured to sample a negative sample as described in FIGS. 1-2, according to some embodiments. At each time step, the NNI sampler 208 generates a probability distribution based on the encoded user interest representation. The probability distribution is then used to select a negative sample. For example, user interest representation 314 is decoded to produce probability distribution 308. Probability distribution 308 provides a probability associated with each item (or pre-selected subset of items). The selection of negative sample 302 is based on this probability distribution. In this example, the item with the highest probability is selected, as denoted by the bolded bar in the probability distribution 308.

At a next time step, user interest representation 316 is decoded to produce probability distribution 310. Negative sample 304 is selected based on the probability distribution, however in this example it is the second highest probability item that is selected. In some embodiments, more than one negative item is selected to be used for computing contrastive loss. For example, every sample above the threshold indicated by the dashed line in probability distribution 308 may be selected. The probability of selecting an item in the distribution is controlled by the distribution. As discussed above, by adjusting the parameter α, the “strength” of “difficulty” of the training may be increased or decreased. A higher α means that the sampler is even more likely to choose the highest probability item. When α is set to 0, the distribution is flattened, and the sampling becomes effectively uniform across all items. In some embodiments, α may be self-adjusted. For example, the loss value in each batch is used to determine if the current value of a is too hard or too easy. When the previous loss is larger than the current loss, α is increased, otherwise α is decreased. In this way, α may be self-adjusted with the online loss value as feedback. In embodiments where all items above a threshold are selected, increasing α may increase the number of items selected, while decreasing α may decrease the number of items selected. Alternatively, rather than a threshold, the system may have a predetermined number of negative samples desired (e.g., k samples), and the sampler selects the top k items in the probability distribution.

One more example is illustrated where user interest representation 318 is decoded to produce probability distribution 312. Based on probability distribution 312, negative sample 306 is selected. During training, the encoder 212 which produces user interest representations is updated, thereby causing the sampler to select items that reflect the latest understanding of user interest based on the encoder 212.

In one embodiment, the selected negative sample 304 may be re-used in the next training timestep. For example, the user interacted items from time 1 to t−1 may be used to predict the next item at time t, which is used as the negative sample in the current training step. At the next training step, the updated model may re-predict the next item for time t based on the user interacted items from time 1 to t−1, which is again used as the negative sample.

In another embodiment, the negative sample 304 may be generated along the time axis during the training process. For example, the user interacted items from time 1 to t−1 may be used to predict the next item at time t, which is used as the negative sample in the current training step. At the next training time step, the user interacted items from time 1 to 5 may be used to predict the next item at time t+1. The predicted item at t+1 may then be sampled as the negative sample at the next training timestep—accordingly, the positive sample may be chosen as the (t+1)th user interacted item from the training data.

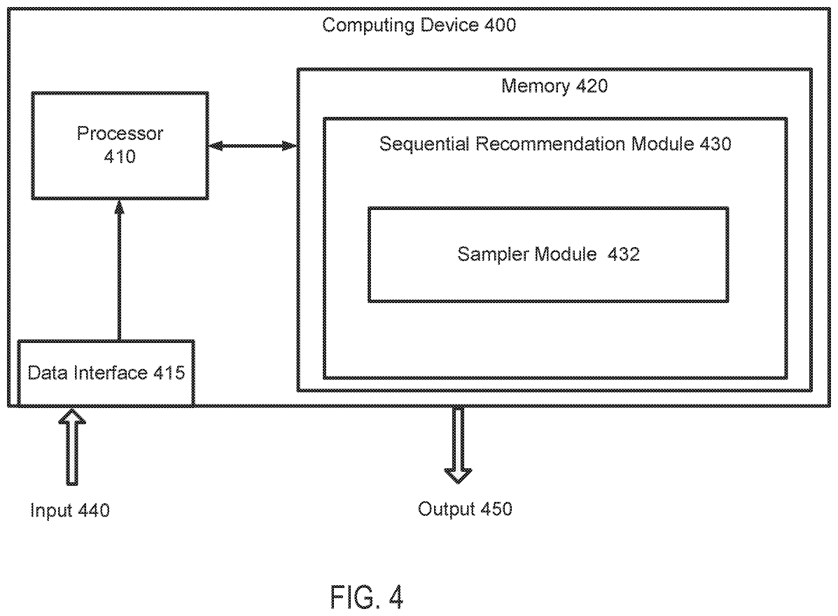

FIG. 4 illustrates a simplified diagram of a computing device that generates negative items according to some embodiments. As shown in FIG. 4, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for a sequential recommendation module 430 that may be used to implement and/or emulate the systems and models, and/or to implement any of the methods described further herein. In some examples, the sequential recommendation module 430, may receive an input 440, e.g., such as a text document, via a data interface 415. The data interface 415 may be a communication interface that may receive or retrieve previously stored documents from a database. The sequential recommendation (SR) module 430 may generate an output 450, such as a next item prediction based on the input 440. In some embodiments, the sequential recommendation module 430 may further include a sampler module 432.

The SR module 430 is configured to perform functions as described with respect to FIGS. 2-3. For example, SR module 430 may be configured to train a sequential recommendation model. Specifically, SR module 430 may encode user historical behaviors to produce user interest representations. The user interest representation may be used by a NNI sampler to select negative samples. SR module 430 may use the selected negative samples together with positive samples based on the next item in the user historical behavior to produce a contrastive loss. The model may be updated by SR module 430 based on the contrastive loss.

The sampler module 432 is configured to perform functions as described with respect to FIGS. 2-3. Sampler module may perform the functions of the NNI sampler of the SR module 430. Specifically, sampler module 432 may, at each time step of a training sequence, generate a probability distribution based on the encoded user interest representation. The probability distribution is then used by the sampler module 432 to select a negative sample. The probability distribution provides a probability associated with each item (or pre-selected subset of items). The sampler module 432 may be configured to select a negative sample based on the probability distribution. For example, the likelihood of the sampler module 432 selecting a particular item may be directly proportional to the probability associated with that item in the probability distribution. A parameter may adjust how strongly the probability distribution is exaggerated or flattened for the purpose of selecting a negative sample.

Some examples of computing devices, such as computing device 400 may include non-transitory, tangible, machine readable media that include executable code that when run by one or more processors (e.g., processor 410) may cause the one or more processors to perform the processes of methods described herein. Some common forms of machine-readable media that may include the processes of methods described herein are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

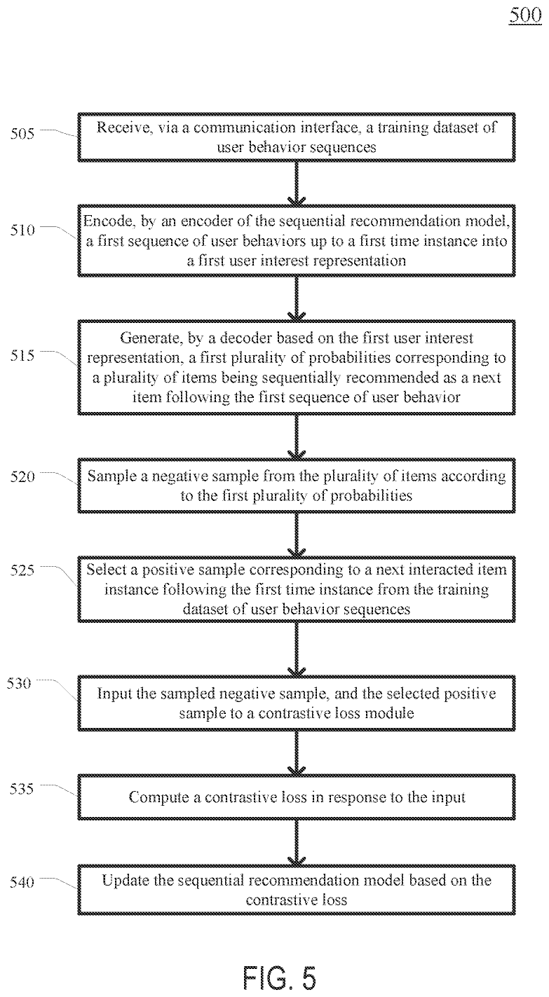

FIG. 5 provides an example logic flow diagram 500 illustrating an example algorithm for training a sequential recommendation model, according to some embodiments. One or more of the processes described in FIG. 5 may be implemented, at least in part, in the form of executable code stored on non-transitory, tangible, machine-readable media that when run by one or more processors may cause the one or more processors to perform one or more of the processes 505-540. In some embodiments, method 500 may correspond to the method used by the sequential recommendation module 430 in FIG. 4.

At step 505, a communication interface (e.g., see data interface 415 in FIG. 4) may receive a training dataset of user behavior sequences (e.g., see 210 in FIG. 2). For example, the plurality of user behavior sequences may be loaded in the form of a database file from a local database, a cloud database, and/or the like.

At step 510, an encoder (e.g., see encoder 212 in FIG. 2) of a sequential recommendation model encodes a first sequence of user behaviors up to a first time instance into a first user interest representation. Additional details of the operation of encoder 212 are discussed in relation to FIG. 2.

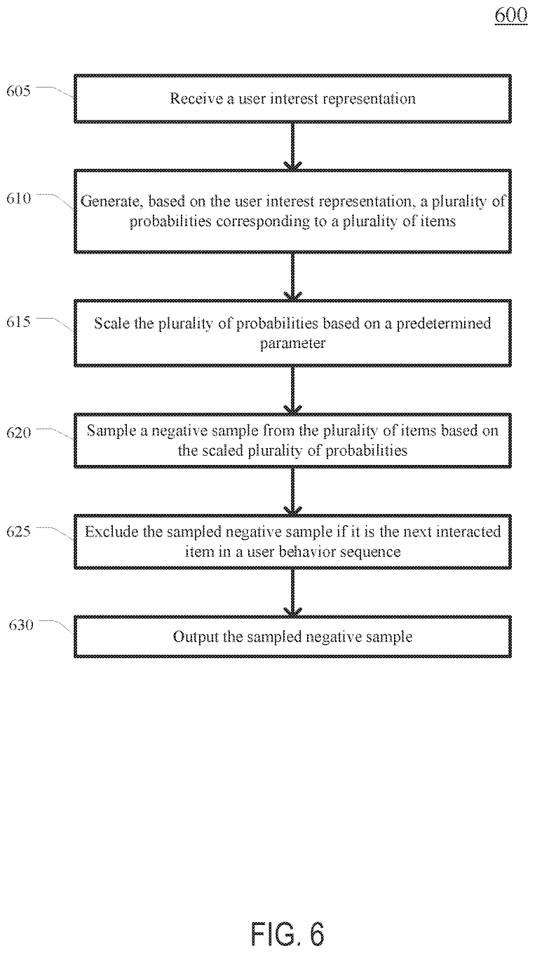

At step 515, a decoder (e.g., see sampler 208 in FIG. 2) of the sequential recommendation model generates, based on the first user interest representation a first plurality of probabilities corresponding to a plurality of items being sequentially recommended as a next item following the first sequence of user behavior. The probabilities may be determined based on a distance in feature space between each item and the current user interest representation. The decoder may function as described with reference to FIGS. 3 and 6.

At step 520, the decoder selects a negative sample from the plurality of items according to the first plurality of probabilities. For example, the sampler may use a process as described with reference to FIG. 6 to select the item.

At step 525, the system selects a positive sample corresponding to a next interacted item instance following the first time instance from the training dataset of user behavior sequences. For example, as shown in FIG. 1, running shoes 102 may be used as a positive sample after water bottle 104.

At step 530, the system inputs the sampled negative sample and the selected positive sample to a contrastive loss module. In some embodiments, the sampler 208 samples a plurality of negative samples per one next item prediction at one training time step which are input to the sequential recommendation model. In other embodiments, only one negative sample is sampled per one next item prediction at one training time step.

At step 535, the contrastive loss module (e.g., Sequential BCE loss 216 in FIG. 2) computes a contrastive loss in response to the input. For example, the model may use sequential binary cross entropy to compute the loss.

At step 540, the system updates the sequential recommendation model (e.g., the encoder 212 and/or the sampler/decoder 208) based on the contrastive loss. The next training iteration, the encoder is updated, and since the sampler is ultimately based on the output of the sampler, it is dynamically adjusting over time.

FIG. 6 provides an example logic flow diagram 600 illustrating an example algorithm for sampling negative items, according to some embodiments. One or more of the processes described in FIG. 6 may be implemented, at least in part, in the form of executable code stored on non-transitory, tangible, machine-readable media that when run by one or more processors may cause the one or more processors to perform one or more of the processes 605-630. In some embodiments, method 600 may correspond to the method used by the NNI sampler 208, or sampler module 432 in FIG. 4.

At step 605, a sampler (e.g., see sampler 208 in FIG. 2) receives a user interest representation. For example, the user interest representation may be received from an encoder as described with reference to FIGS. 2 and 5.

At step 610, the sampler generates, based on the user interest representation, a plurality of probabilities corresponding to a plurality of items. The probabilities may be generated, for example, using the Q(⋅) function as described herein.

At step 615, the sampler scales the plurality of probabilities based on a predetermined parameter. For example, the parameter α as discussed with reference to FIG. 3 and shown in the Q(⋅) function.

At step 620, the sampler samples a negative sample from the plurality of items based on the scaled plurality of probabilities. In some embodiments, more than one negative sample is selected. For example, every sample over a predetermined threshold may be selected. In another embodiment, a predetermined number of items is selected. A particular item of the plurality of items associated with a higher probability of the scaled plurality of probabilities than a second particular item of the plurality of items, has a higher probability of being selected. In some embodiments, the negative sample is selected from a preselected subset of the items. This may be controlled, for example, by the parameter as described with reference to FIG. 2. In some embodiments, stays fixed during training. In some embodiments, increases as training is performed.

At step 625, the sampler excludes the selected negative sample if it is the next interacted item in a user behavior sequence. This is because in this instance the model predicted correctly the next item, and the model would not improve by using that correct prediction as a negative sample. In other words, the sampler is constrained from selecting the next interacted item from the plurality of user behavior sequences. For example, as shown by the qualifier sᵢ≠sₜ₊₁^{u} in the Q(⋅) function as described herein.

At step 630, the sampler outputs the sampled negative sample. In some embodiments, the negative sample (or samples) are used to compute a contrastive loss which is used to update the model.

FIGS. 7-11 provide example tables illustrating performance of different models according to some embodiments. One of the models compared is SASRec as described in Kang et al., Self-attentive sequential recommendation, ICDM. IEEE, pages 197-206, 2018. Another model is S³-Rec as described in Zhou et al., Self-supervised learning for sequential recommendation with mutual information maximization, Proceedings of the 29^{th} ACM International Conference on Information & Knowledge Management, pages 1893-1902, 2020. Another model is Caser as described in Tang et al., Personalized top-n sequential recommendation via convolutional sequence embedding, WDM, pages 565-573, 2018. Another model is GRU4Rec as described in Hidasi et al., Session-based recommendations with recurrent neural networks, arXiv preprint arXiv:1511.06939, 2015. Another model is MMInfoRec as described in Qiu et al., Memory Augmented Multi-Instance Contrastive Predictive Coding for Sequential Recommendation, arXiv preprint arXiv:2109.00368, 2021. Each of these aforementioned models are used for baseline comparison and were trained with uniform sampling of negative samples. Also included in comparisons were models with GenNi based sampling. GenNi applied to SASRec is denoted as GenNi_{SA}. GenNi applied to S³-Rec is denoted as GenNi_{S}³.

FIG. 7 illustrates a validation set performance with respect to training time on a beauty dataset. Replacing the uniform sampler with GenNi does introduce additional computation cost. For example, SASRec spends 2.44 seconds on model updates for one epoch while GenNi_{SA} (β=1) requires 6.30 s/epoch. However, GenNi_{SA} converges to much higher performance and requires fewer training epochs to converge. What's more, as β is reduced to 0.1, GenNi_{SA} (β=0.1) only needs 2.47 seconds to update the model for one epoch, which is close to SASRec (2.44 s/epoch), and still performs better than SASRec. Although MMInfoRec is the best performing baseline, it requires 34.22 seconds on model updates for one epoch. GenNi_{SA} with β=1.0 and GenNi_{SA} with β=0.1 are over 5.42 and 13.85 times faster and also perform better than MMInfoRec.

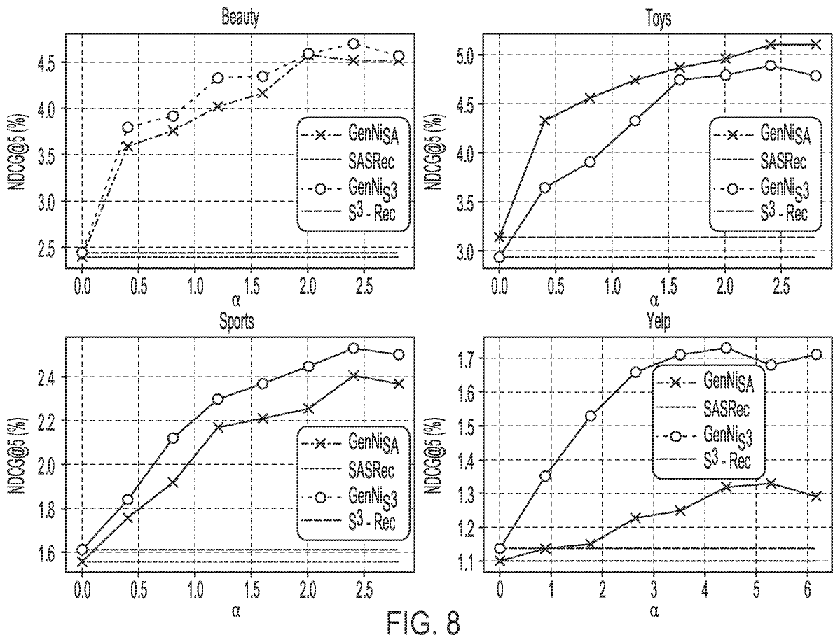

FIG. 8 illustrates performance with respect to a that controls the informativeness (difficulty) of sampled negative items. When α=0, negative items are uniformly sampled. The charts in FIG. 8 show the influence of α on model performance over four datasets. The model performance increases as α increases at the beginning, and then the performance reaches a peak. Specifically, when α=2.5, the model performs best on Beauty, while α=4.4, the model performs best on Yelp. The large a shows that randomly sampled items can be uninformative as training proceeds, while considering items that are currently hard to be correctly classified can further improve the model. Similar observations are found on Sports and Toys.

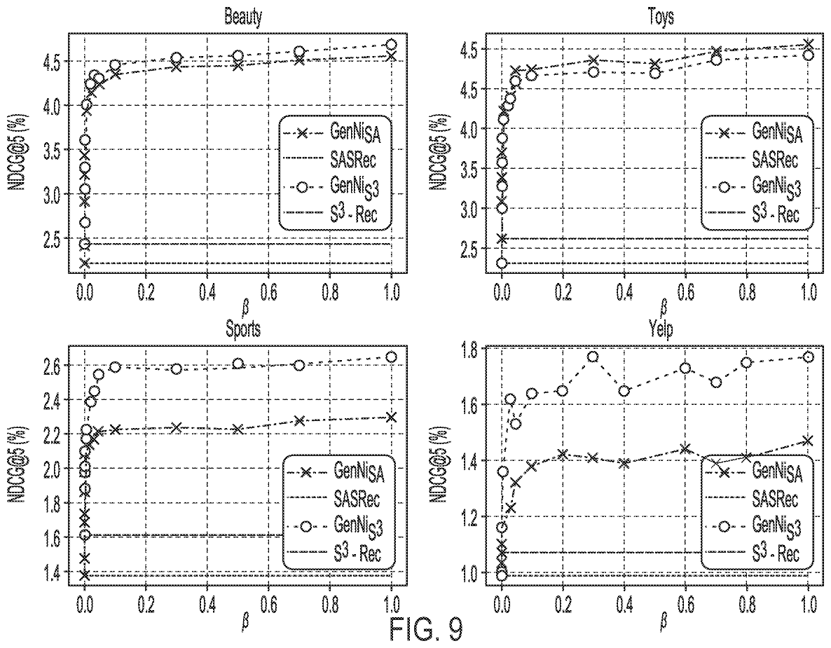

FIG. 9 illustrates performance with respect to β for accelerating negative item generation. When β≈0, GenNi is no longer needed and the negative items are sampled under a uniform distribution. The charts in FIG. 9 show that there is an elbow point of β that balances the effectiveness and efficiency of GenNi well. For example, when β=0.1, it reduces about 90% computation cost of GenNi while the model can still achieve about 95% performance (e.g., NDCG@5) of its original version (β=1.0) in Beauty. On one hand, it shows the superiority of GenNi, which takes the efficiency of randomly sampling to pre-select a certain portion of items in the first stage and then concentrates on finding informative ones with a slower but more accurate sampling strategy. On the other hand, the decreasing of performance with small β also indicates that with the training goes, the number of informative items also decreasing so too small β can filter out all these items in pre-selection stage.

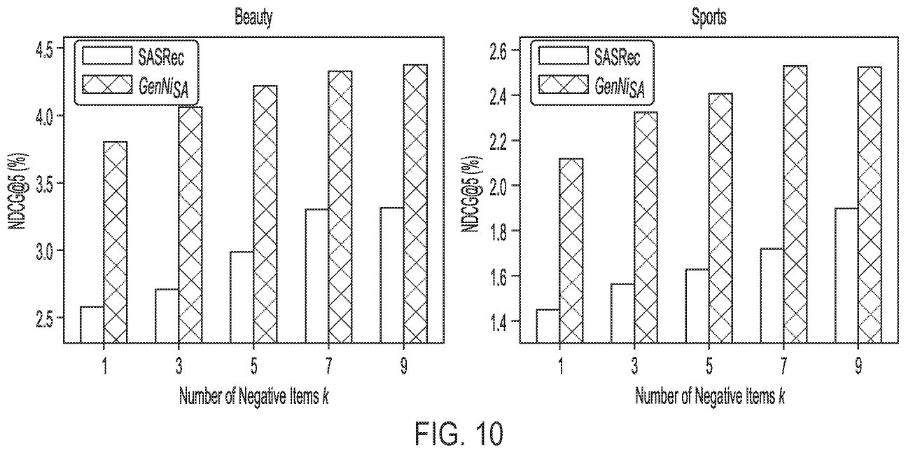

FIG. 10 illustrates the impact of the number of negative samples selected. As shown, there is a diminishing return in the performance improvement for both SASRec and GenNiSA. However GenNiSA can consistently outperform SASRec, which further verifies the importance of sampling informative negative items. Note that training with additional negative samples linearly increases the time cost. While GenNiSA can even achieve better performance with only 1 negative sample compared with SASRec that uses 9 negative samples on Beauty and Sports.

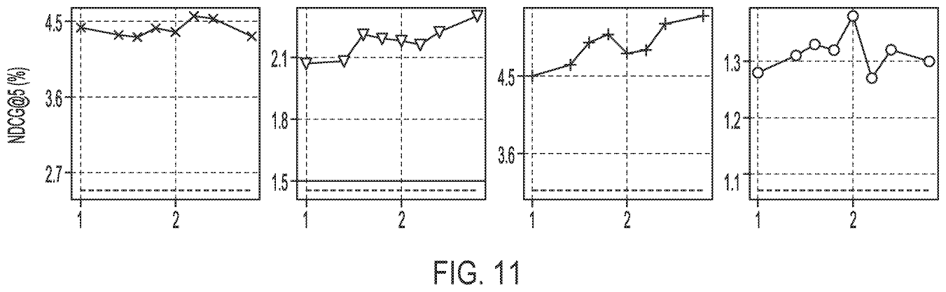

FIG. 11 illustrates performance with respect to initial value of a when employing self-adjusted curriculum learning. The bottom dashed line in each chart is the performance of SASRec for comparison. As shown, the model performance with GenNi is less sensitive to the initial a value.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. A method for training a sequential recommendation model via contrastive learning, comprising:
receiving, via a communication interface, a training dataset of user behavior sequences;
encoding, by an encoder of the sequential recommendation model, a first sequence of user behaviors up to a first time instance into a first user interest representation;
generating, by a decoder based on the first user interest representation, a first plurality of probabilities corresponding to a plurality of items being sequentially recommended as a next item following the first sequence of user behavior;
sampling a negative sample from the plurality of items according to the first plurality of probabilities;
selecting a positive sample corresponding to a next interacted item at a next time instance following the first time instance from the training dataset of user behavior sequences;
inputting the sampled negative sample, and the selected positive sample to the sequential recommendation model;
computing a contrastive loss in response to the inputting; and
updating the sequential recommendation model based on the contrastive loss.

2. The method of claim 1, wherein the generating comprises:
computing a distance in a feature space between the user interest representation and representations of the plurality of items.

3. The method of claim 1, wherein the computing the contrastive loss comprises:
computing a first distance in a feature space between a representation of the sampled negative sample and the first user interest representation;
computing a second distance in feature space between a representation of the selected positive sample and the first user interest representation; and
computing the contrastive loss based at least in part on the first distance and the second distance.

4. The method of claim 1, wherein a first particular item of the plurality of items associated with a higher probability of the first plurality of probabilities than a second particular item of the plurality of items, has a higher probability of being sampled.

5. The method of claim 1, wherein the sampling the negative sample is constrained from sampling the next interacted item from the first sequence of user behavior.

6. The method of claim 1, wherein the updating the sequential recommendation model comprises updating the encoder based on the contrastive loss.

7. The method of claim 1, wherein the sampling the negative sample comprises:
scaling the first plurality of probabilities based on a scaling parameter; and
sampling the negative sample according to scaled probabilities.

8. The method of claim 1, wherein the sampling the negative sample further comprises:
controlling a quantity of items in a subset of the plurality of items according to an adjustable parameter; and
sampling the negative sample from the subset of the plurality of items,
wherein the adjustable parameter is a pre-defined constant throughout a training stage of the sequential recommendation model, or
gradually increased throughout the training stage of the sequential recommendation model.

9. The method of claim 8, further comprising:
sampling a plurality of negative samples per one next item prediction at one training time step.

10. The method of claim 1, further comprising:
after updating the sequential recommendation model based on the contrastive loss:
re-using the first sequence of user behaviors for training the updated sequential recommendation model at a next training timestep.

11. The method of claim 1, further comprising:
after updating the sequential recommendation model based on the contrastive loss:
including the next interacted item into the first sequence of user behaviors resulting in a second sequence of user behaviors;
encoding the second sequence of user behaviors into a second user interest representation;
generating a second plurality of probabilities corresponding to the plurality of items being sequentially recommended as a next item following the second sequence of user behavior;
sampling another negative sample from the plurality of items according to the second plurality of probabilities; and
using the other negative sample for contrastive learning with the updated sequential recommendation model.

12. A system for sequential recommendation, the system comprising:
a memory that stores a sequential recommendation model;
a communication interface that receives a plurality of user behavior sequences; and
one or more hardware processors that:
receives, via a communication interface, a training dataset of user behavior sequences;
encodes, by an encoder of the sequential recommendation model, a first sequence of user behaviors up to a first time instance into a first user interest representation;
generates, by a decoder based on the first user interest representation, a first plurality of probabilities corresponding to a plurality of items being sequentially recommended as a next item following the first sequence of user behavior;
samples a negative sample from the plurality of items according to the first plurality of probabilities;
selects a positive sample corresponding to a next interacted item at a next time instance following the first time instance from the training dataset of user behavior sequences;
inputs the sampled negative sample, and the selected positive sample to the sequential recommendation model;
computes a contrastive loss in response to the inputting; and
updates the sequential recommendation model based on the contrastive loss.

13. The system of claim 12, wherein the generating comprises:
computing a distance in a feature space between the user interest representation and representations of the plurality of items.

14. The system of claim 12, wherein the computing the contrastive loss comprises:
computing a first distance in a feature space between a representation of the sampled negative sample and the first user interest representation;
computing a second distance in feature space between a representation of the selected positive sample and the first user interest representation; and
computing the contrastive loss based at least in part on the first distance and the second distance.

15. The system of claim 12, wherein a first particular item of the plurality of items associated with a higher probability of the first plurality of probabilities than a second particular item of the plurality of items, has a higher probability of being sampled.

16. The system of claim 12, wherein the sampling the negative sample is constrained from sampling the next interacted item from the first sequence of user behavior.

17. The system of claim 12, wherein the updating the sequential recommendation model comprises updating the encoder based on the contrastive loss.

18. A processor-readable non-transitory storage medium storing a plurality of processor-executable instructions for a sequential recommendation model, the instructions being executed by a processor to perform operations comprising:
receiving, via a communication interface, a training dataset of user behavior sequences;
encoding, by an encoder of the sequential recommendation model, a first sequence of user behaviors up to a first time instance into a first user interest representation;
generating, by a decoder based on the first user interest representation, a first plurality of probabilities corresponding to a plurality of items being sequentially recommended as a next item following the first sequence of user behavior;
sampling a negative sample from the plurality of items according to the first plurality of probabilities;
selecting a positive sample corresponding to a next interacted item at a next time instance following the first time instance from the training dataset of user behavior sequences;
inputting the sampled negative sample, and the selected positive sample to the sequential recommendation model;
computing a contrastive loss in response to the inputting; and
updating the sequential recommendation model based on the contrastive loss.

19. The processor-readable non-transitory storage medium of claim 18, wherein the generating comprises:
computing a distance in a feature space between the user interest representation and representations of the plurality of items.

20. The processor-readable non-transitory storage medium of claim 18, wherein the computing the contrastive loss comprises:
computing a first distance in a feature space between a representation of the sampled negative sample and the first user interest representation;
computing a second distance in feature space between a representation of the selected positive sample and the first user interest representation; and
computing the contrastive loss based at least in part on the first distance and the second distance.
